(19) United States
(12) Patent Application Publication
(10) Pub. No.: US 2009/0204925 A1
(43) Pub. Date: Aug. 13, 2009

(54) Active Desktop with Changeable Desktop Panels

(75) Inventors: Udupi Ramanath Bhat, San Diego, CA (US); Rui Yamagami, Malmo (SE)

Correspondence Address: COATS & BENNETT/SONY ERICSSON, 1400 CRESCENT GREEN, SUITE 300, CARY, NC, 27518, US

(73) Assignee: Sony Ericsson Mobile Communications AB, Lund (SE)

(21) Appl. No.: 12/034,266

(22) Filed: Feb. 20, 2008

Related U.S. Application Data
(60) Provisional application No. 61/027,215, filed on Feb. 8, 2008.

(51) Int. Cl. G06F 3/048

(52) U.S. Cl. 715/778

(57) ABSTRACT

A desktop environment for a mobile computing device provides the user with multiple user desktops that can be changed on the fly by the user depending upon the particular experience the user desires. The desktop environment comprises a desktop module with a plug-in interface, a plurality of plug-in panels corresponding to respective user desktops, and a panel manager. Each panel contains application code associated with a respective user desktop designed to provide a particular user experience. The desktop panel is configured to plug into the desktop module. The panel manager enables switching between different user desktops by unloading a current desktop panel associated with a first user desktop, and loading a second desktop panel associated with a second user desktop.

### RELATED APPLICATION

This application claims the benefit of U.S. Provisional Patent Application 61/027,215, filed Feb. 8, 2008, which is incorporated herein by reference.

### BACKGROUND

Graphical user interfaces, which typically employ displayed graphics and pointing devices, were developed in the early 1980s to provide an intuitive and convenient method for users to interact with computers. A desktop environment is one type of graphical user interface that is based on a desktop metaphor. The display area is likened to an actual desktop of a user. Graphical objects, or icons, representing files, folders, applications, and devices, can be arranged on the desktop to enable the user to conveniently access computing resources. In most desktop environments, applications run in windows that overlie the desktop and cover desktop objects. Each application window is typically associated with a particular software program. One drawback to windowing desktop environments is that the display area can become cluttered with numerous icons and application windows, which cause the user to spend an inordinate amount of time manipulating application windows and other objects on the desktop.

One drawback to conventional desktop environments is that typical user desktop provides a static user experience. The desktop environment is used primarily as a platform for launching user applications. Some desktop environments enable plug-ins to allow third parties to add features to the user desktop. However, the set of features present in the user desktop is generally static over time.

Virtual desktops have been used in the past to avoid the problem of window clutter in desktop environments. Virtual desktop systems allow the user to have multiple instances of the desktop open at any given time. The user can open different applications in the different user desktop instances to avoid the problem of window clutter. However, virtual desktop systems do not change the basic static nature of the desktop environment because the virtual desktop system simply replicates the same static desktop multiple times to create virtual desktops. Further, virtual desktop systems require significant memory resources and thus are not well-suited for mobile computing devices with limited memory and processing resources.

Accordingly, a new approach to desktop environments is needed to provide a more dynamic user experience that is compatible with mobile computing devices.

### SUMMARY

The present invention relates to a desktop environment for a mobile computing device that provides the user with multiple user desktops that can be changed on the fly by the user depending upon the particular experience the user desires. The desktop environment comprises a desktop module with a plug-in interface, a plurality of plug-in panels corresponding to respective user desktops, and a panel manager. Each panel contains application code associated with a respective user desktop designed to provide a particular user experience. The desktop panel is configured to plug into the desktop module. The panel manager enables switching between different user desktops by unloading a current desktop panel associated with a first user desktop, and loading a second desktop panel associated with a second user desktop.

According to one exemplary embodiment, the desktop panel manager may display a selection panel when the user presses a predetermined button on the mobile computing device. The selection panel displays thumbnail images of the user desktops on the display of the mobile computing device. The panel manager detects user input indicating selection of a user desktop, and loads the desktop panel corresponding to the selected user desktop into the desktop module.

In other embodiments, the panel manager can switch user desktops responsive to detection of predetermined events. The user can create an association between the predetermined events and selected panels so that different user selected panels are displayed responsive to the predetermined events.

### BRIEF DESCRIPTION OF THE DRAWINGS

FIG. 1 is illustrates an exemplary mobile computing device.

FIG. 2 illustrates the main functional elements of a mobile computing device.

FIG. 3 illustrates an exemplary desktop environment for a mobile computing device including changeable desktop panels.

FIG. 4 illustrates the main elements of a user desktop associated with a desktop panel.

FIG. 5 illustrates an exemplary selection panel for switching desktop panels.

FIG. 6 illustrates selection panels with a thumbnail image enlarged and highlighted to indicate focus.

FIG. 7 illustrates a transition from full view of a current user desktop to an arc selection panel.

FIG. 8 illustrates a transition from full view of a current user desktop to a tile selection panel.

FIGS. 9 and 10 illustrate exemplary user interface operation in one embodiment.

FIG. 11 illustrates exemplary control panels for setting user preferences and controlling behavior of desktop panels.

### DETAILED DESCRIPTION

The present invention relates to a desktop panel-based desktop environment for mobile computing devices. Mobile computing devices are typically characterized by small displays, limited memory, and limited processing resources. The present invention overcomes these limitations by providing a desktop environment with multiple, switchable desktop panels. Each desktop panel contains both application code and graphical elements that define a particular user experience. For example, a media desktop panel can be provided to play and manage media content in the user's multimedia library. The desktop panels plug into a desktop module that contains common components of the desktop environment. The desktop module, in combination with the current desktop panel, defines the current user desktop. A desktop panel manager enables the user to change desktop panels and thus change the current user desktop.

The desktop panel architecture provides an extensible framework that enables network operators, service providers, and third party vendors to create and distribute their own desktop panels. Network operators can create customized desktop panels that are preloaded into the user devices, along with a standard set of desktop panels provided by the device manufacturer. Users can also download desktop panels and install the downloaded desktop panels into the desktop environment. The user can select which desktop panels to include in the desktop environment.

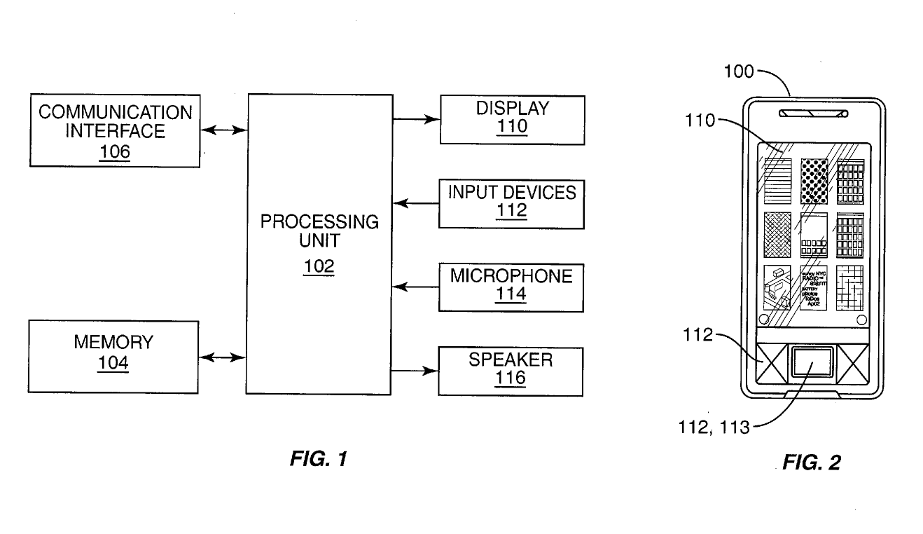

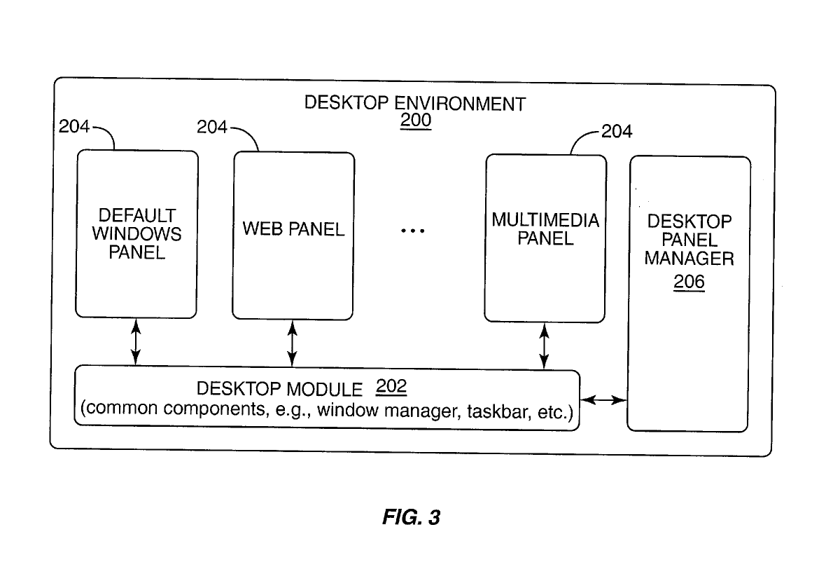

FIGS. 1 and 2 illustrate an exemplary mobile computing device for implementing a panel-based desktop environment. The mobile computing device 100 typically comprises, in its most basic configuration, a processing unit 102, memory 104, communication interface 106, and user interface 108. The processing unit 102 may comprise one or more microcontrollers, microprocessors, hardware, or a combination thereof. Memory 104 may comprise volatile memory such as random access memory, non-volatile memory such as read-only memory, FLASH memory, etc., or some combination of the two. The communication circuit 106 enables the mobile computing device 100 to communicate with other devices over communication networks. The communication circuit 106 may provide interfaces for communicating over one or more networks including cellular networks (e.g., WCDMA, CSM), wireless local area networks (e.g., WiFi, WiMax), and conventional wireline networks. User interface 108 comprises a collection of devices to enable the user to interact with the mobile computing device 100. The most basic components of the user interface 108 include a display 110, one or more user input devices 112, microphone 114, and speaker 116. The display 110 may comprises a touch screen display that also functions as a user input device 112. User input devices may comprise keys, buttons, touchpads, joysticks, trackballs, and other such devices. In the exemplary embodiment, the user input devices 112 include a hardware button or key 114 that is accessible to the user for switching desktop panels as hereinafter described.

The mobile computing device 100 may also have additional features not illustrated in FIG. 1. For example, the mobile computing device 100 may include mass storage devices or other hardware to enable users to store data in a variety of storage media. The mobile computing device 100 may include magnetic or optical disk drives, or suitable interfaces, e.g., USB, FIREWIRE, etc., for connecting to external storage devices.

The mobile computing device 100 includes an operating system program stored in memory 104 that manages the sharing of system resources and provides application programmers with an interface used to access those resources. The operating system program also provides a graphical user interface (GUI) to facilitate user interaction with the mobile computing device 100. The graphical user interface includes a desktop environment that provides multiple, context-specific user desktops to the user. Each user desktop includes a set of applications, functions, and user interface elements designed to create a unique user experience. The user can easily change the user desktop depending on the particular experience that the user desires.

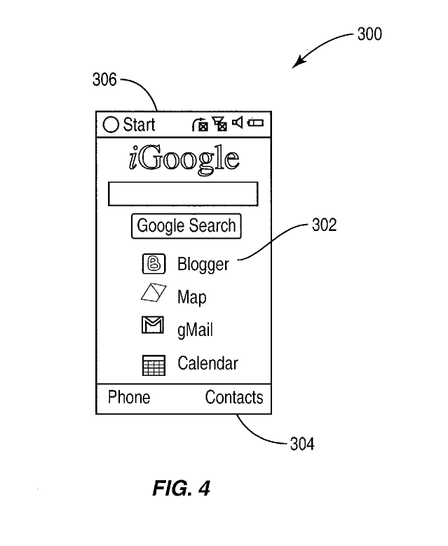

FIG. 3 illustrates the main functional components of an exemplary desktop environment 200 according to the present invention. Those skilled in the art will appreciate that the various components shown in FIG. 3 are typically implemented as software components. The desktop environment 200 includes a desktop module 202, a plurality of switchable desktop panels 204, and a desktop panel manager 206. The desktop module 202 comprises a desktop application having a plug-in application programming interface (API) 208 that provides a programming interface for the desktop panels 204. The desktop module 202 may further include a window manager and common components of the different user desktops. Each desktop panel 204 comprises a full-screen plug-in that loads in to the desktop module 202. Each desktop panel 204 includes application code and graphical elements designed to provide a particular user experience. In one exemplary embodiment, the desktop panel 204 may comprise a single dynamically linked library (DLL) that encapsulates applications and user interface elements (e.g., user desktop) that define a particular user experience. DLLs are libraries of subroutines that are loaded into application programs at runtime rather than when the application is compiled, and remain as separate files in memory. A program called a loader or linker, which is typically part of the underlying operating system, finds the relevant DLLs when they are needed and writes the relevant subroutines into the calling process' memory space.

In one embodiment, the user may have any desired number of desktop panels 204, but only nine desktop panels 204 can be enabled. At any given time, one of the enabled desktop panels 204 is selected to be the active desktop panel 204. The desktop panel manager 206 allows the user to switch the currently active desktop panel 204. When the desktop panels 204 are switched, the currently active desktop panel 204 is unloaded from the desktop module 202 and the new desktop panel 204 is loaded in to the desktop module 204.

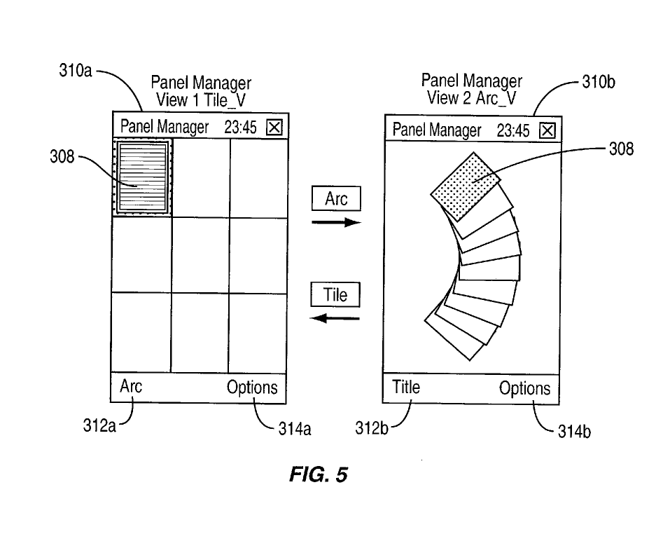

The desktop module 202 and the currently active desktop panel 204 create the user desktop that the user sees on the display 110 of the mobile computing device 100. The user desktop comprises the visual aspect of the user experience. FIG. 4 illustrates the main elements of an exemplary user desktop 300 that is displayed on the display 110 of a mobile computing device 100. The exemplary user desktop 300 comprises a desktop panel area 302, taskbar 304, and windows bar 306. In a preferred embodiment of the invention, the desktop panel area 302, task bar 304, and window bar 306 use the entire available area of the display 110. The desktop panel area 302 is the main part of the user desktop and varies from one desktop panel 204 to another. The taskbar 304 and menu bar 306 are common components of multiple user desktops. These elements are defined by the desktop module 102 and may be overlayed on a full-screen desktop panel area 302. Those skilled in the art will appreciate that the taskbar 304 and window bar 206 could, however, be included as part of the desktop panel 204. Further, those skilled in the art will appreciate that components that appear on the task bar 204 and window bar 206 may change depending on the currently active desktop panel 204.

A user can switch between user desktops by simply changing the currently active desktop panel 204. To switch desktop panels 204, the user invokes the desktop panel manager 206. The user can invoke the desktop panel manager 206 in a number of ways. For example, the mobile computing device 100 may include a dedicated button or key 114 that is pressed by the user to invoke the desktop panel manager 206. The active desktop panel 204 may display a virtual button that is selected by the user with a pointing device to invoke the desktop panel manager 206. The desktop panel manager 206 may also be invoked by voice commands. In some embodiments, the desktop panel manager 206 may also be invoked automatically responsive to predetermined events.

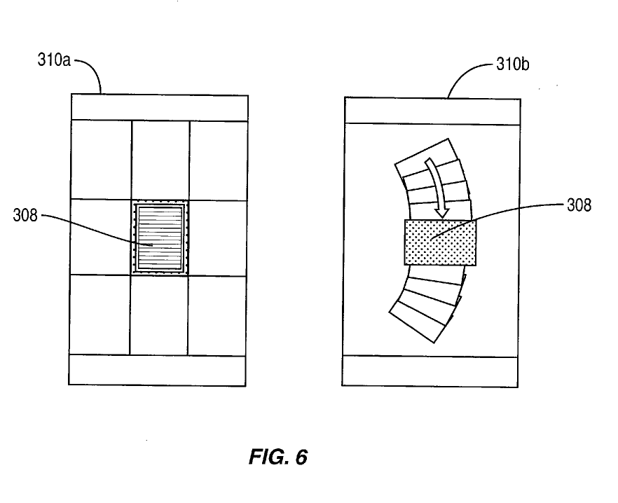

When the desktop panel manager 206 is invoked, the current user desktop is replaced by a selection panel 300a, 300b as shown in FIG. 5. The selection panel 300a, 300b is not a desktop panel 204; but is a user input screen or user dialog box to enable the user to switch the active desktop panel 204. The selection panel 300a, 300b includes thumbnail views 302 of user desktops associated with each of the enabled desktop panels 204. Each thumbnail view 302 comprises a proportionally scaled down version a corresponding user desktop associated with a particular desktop panel 204. From the selection panel 300a, 300b, the user can switch from a currently active desktop panel 204 to a different desktop panel 204 by tapping or clicking on the thumbnail image 302 of the user desktop associated with the desired desktop panel 204. The selection of the desired desktop panel 204 can be made, for example, by using a pointing device such as a mouse, trackball, touch pad, or joystick control. The pointing device can be used to move an on-screen cursor and pressing a button on the pointing device to select the object (e.g., mouse click). If the mobile computing device 100 includes a touch screen, the selection of the desktop panel 204 can be made by tapping the thumbnail representation of the user desktop.

Once a selection is made by the user, the selection panel 300a, 300b is replaced on the display 110 by the user desktop corresponding to the selected desktop panel 204. More particularly, the desktop panel manager 206 unloads the currently active desktop panel 204 from the desktop module 202 and loads the selected desktop panel 204 in to the desktop module 202. More particularly, the panel manager 206 causes a loader (usually part of the operating system) to remove the subroutines associated with the currently active panel 204 from the memory space of the desktop module 202. This releases the memory resources that are used by the applications associated with the currently active panel 204 so that they may be used for the selected panel 204. The panel manager 206 then causes the loader to load the subroutines associated with the selected panel 204 into the desktop module's memory space. Once the selected desktop panel 204 is loaded, the user desktop associated with the selected desktop panel 204 becomes the active desktop panel 204 and is presented on the display 110. As described in more detail below, various animation effects can be used to provide seamless transitions between the selection panel 300a, 300b and the full-screen user desktop.

The panel architecture deviates from conventional virtual desktop functionality in that virtual desktops simply switch between different instances of the same desktop application. Thus, there is no need to free memory or other resources when switching between virtual desktops because those resources are continuously in use by the desktop application. However, such conventional techniques are not well-suited to the limited resources typically available with mobile computing devices. Therefore, the present invention switches between different desktops by loading and unloading the desktop panels 204. In doing so, the present invention frees the resources used by the currently active panel, and reallocates those resources to the applications and functions being loaded with the selected desktop panel.

FIG. 5 illustrates two exemplary selection panels 300a, 300b according to one embodiment. The two selection panels are referred to herein, respectively, as the tile selection panel 300 (on the left in FIG. 5) and the arc selection panel 300b (on the right in FIG. 5). In the examples shown in FIG. 5, it is assumed that there are nine desktop panels 204, although those skilled in the art will appreciate that there is no inherent limitation on the number of desktop panels 204 or user desktops that could be used in the present invention. The tile selection panel 300a tiles the thumbnail images 302 of the user desktops on the display 110, i.e., arranges the thumbnail images side by side horizontally and vertically. In the case of nine desktop panels 204, the thumbnail images 302 of the user desktops can be arranged in a 3×3 rectangular array. On the tile selection panel 300a, the thumbnail images 302 do not overlap and each thumbnail image 302 is fully visible. The arc selection panel 300b displays the thumbnail images 302 in an arc pattern with the thumbnail images 302 overlapping one another. In this view, only one thumbnail image 302 is fully visible at a time.

The user can invoke either the tile selection panel 300a or the arc selection panel 300b by using an on-screen control. In this example, a virtual button 306a,306b on the lower left of the selection panel 300 is displayed for transitioning between the tile selection panel 300a and the arc selection panel 300b. Pressing the arc button 306a when the tile selection panel is displayed transitions the arc selection panel. Similarly, pressing the tile button 306b in arc selection panel 300b transitions the tile selection panel 300a. In either view, the user can select the desired desktop panel 204 by tapping or clicking on the thumbnail representation of the corresponding use desktop.

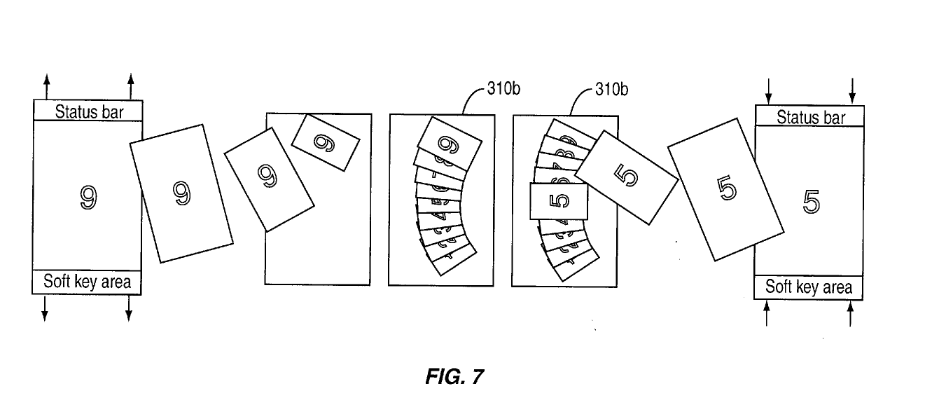

The desktop panel manager 206 preferably allows the user to scroll or navigate through the displayed thumbnail images 302 in both tile and arc preview modes. Scrolling or navigating through the thumbnail images 302 moves the focus from one thumbnail image 302 to another. For example, a scroll bar or 4-way navigation control can be used to navigate through the thumbnail images 302 in the selection panel 300a, 300b. If the mobile computing device 100 includes a touch screen or pointing device, the user can navigate through the thumbnail images by dragging the user's finger or pointer over the displayed thumbnail images 302. When the arc selection panel 300b the thumbnail image 302 with the current focus moves to the forefront of the stack. In either mode, the panel manager 206 may visually distinguish the thumbnail image 302 with the current focus to indicate to the user which desktop panel 204 will be selected. The thumbnail image can be visually distinguished, for example, by highlighting and/or enlarging the thumbnail image with the current focus as shown in FIG. 6.

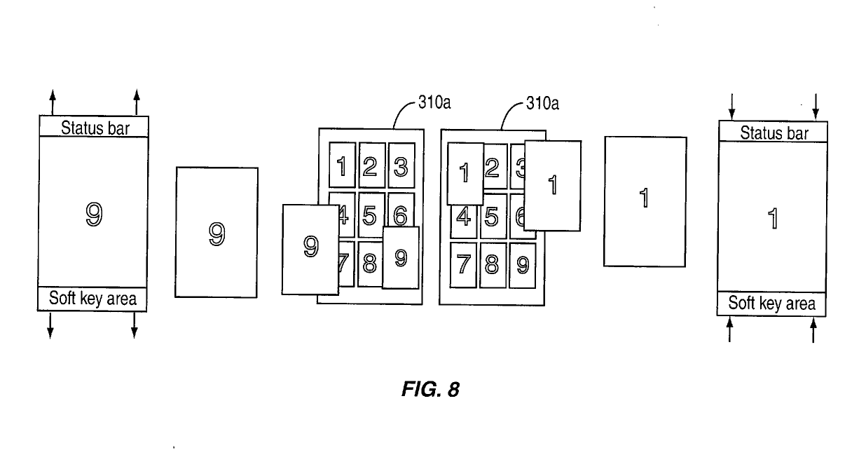

The desktop panel manager 206 may include an animation capability that animates the presentation of the selection panel 300a, 300b to provide a seamless transition from a current user desktop to a selection panel 300a, 300b and vice versa. FIG. 7 illustrates an exemplary animation effect when the user invokes the desktop panel manager 206. The animation begins with the current user desktop in full view. When the user presses a “switch” button 114 on the mobile computing device 100, the current user desktop progressively shrinks and rotates to its position in the selected selection panel 300a, 300b while the inactive user desktops appear out of the background. FIG. 7 illustrates a transition from full view of a current user desktop to the arc selection panel 300b. When the arc selection panel 300b is presented, the user can scroll through the thumbnail images of the user desktops by dragging the user's finger or other pointer over the displayed thumbnail images 302, or by using a scroll bar or other navigation control as previously described. When the user's finger or other pointer touches one of the thumbnail views, the thumbnail view comes to the forefront and enlarges (see FIG. 6). The user can then select the enlarged thumbnail view by tapping the touch screen, by clicking with a pointing device, or by pressing a select key on the mobile computing device. When the user makes a selection, the user desktop associated with the selected desktop panel 204 enlarges and rotates to fill the entire display 110.

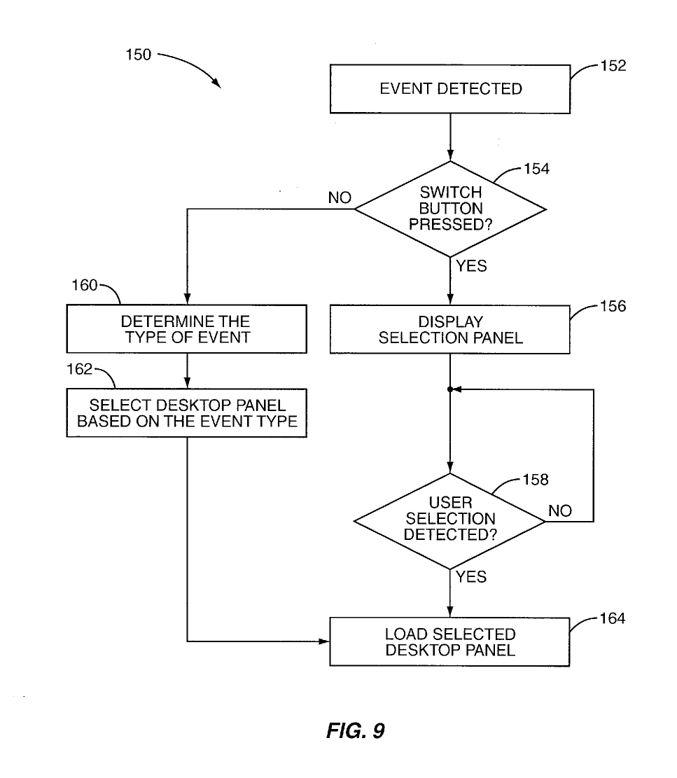

FIG. 8 illustrates an exemplary transition from full view of a current user desktop to the tile view. When the desktop panel manager 206 is invoked, the current user desktop appears to shrink and move into position in the tile pattern. When the user makes a selection, for example, by tapping the touch screen, the desktop associated with the selected desktop panel 204 expands to fill the entire display 110.

In some embodiments of the invention, the desktop panel manager 206 may be configured to automatically change desktop panels 204, and thus change user desktops responsive to predetermined events. Event triggers can be time-based or location-based. For example, the desktop panel manager 206 could be triggered to present a news desktop panel as part of a morning alarm. A calendar program in the mobile computing device 100 may generate time-based event triggers based on scheduled events in the user's calendar. The mobile computing device may include a GPS receiver or other positioning receiver to generate location based event triggers. In this case, desktop panels 204 can be switched depending upon the user's current location. Desktop panels 204 may also be switched based on current conditions. For example, the desktop panels can be switched when the mobile computing device 100 is docked in a charger or docking station, or when the mobile computing device receives an incoming call. Those skilled in the art will appreciate that the present invention is not limited to the specific event triggers enumerated herein, and that other types of event triggers can also be used to trigger the changing of desktop panels 204.

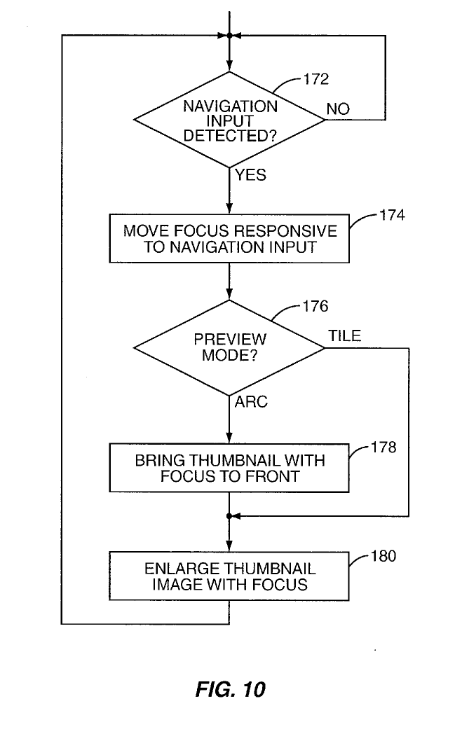

FIG. 9 illustrates user interface operation in one exemplary embodiment. When a desktop panel 204 is active, the panel manager 206 monitors for predetermined events (block 152), which may include user input. When an event is detected, the panel manager 206 determines what triggered the event (blocks 154, 156). If the event was triggered by the user pressing the switch button 114, the panel manager 206 displays the selection panel (block 156) and waits for user input indicating a selection of a desired desktop panel 204 (block 158). When the user makes a selection, the panel manager 206 loads the selected desktop panel (block 164). If some other triggering event occurred, the panel manager 206 determines the type of the event (block 160) and selects a desktop panel based on the event type (block 162). Once a selection is made by either the user or the panel manager 206, the selected desktop is loaded (block 164).

While in panel manager view, the user may scroll or navigate through the thumbnail images 302 on the selection panel 300A, 300B to move the current focus. FIG. 10 illustrates exemplary operation that may occur when the user navigation changes the focus from one thumbnail image to another. When the panel manager 206 detects navigation input by the user (block 172), the panel manager 206 moves the focus from one thumbnail image 302 to another (block 174). If the arc selection panel is displayed (block 176), the panel manager 206 brings the thumbnail image that received the focus to the front (block 178) and enlarges and/or highlights the thumbnail image (block 180). In tile preview mode, the panel manager 206 enlarges and/or highlights the thumbnail image that receives the focus (block 180).

In some embodiments, the user desktops associated with each of the desktop panels 204 may change orientation when the user rotates the mobile computing device 100. For example, the user desktops may be presented in portrait or landscape views depending upon the orientation of the mobile computing device. The mobile computing device may include a sensor to sense orientation of the mobile computing device 100 and change the orientation of the active user desktop. Animation effects similar to those described above can be employed to make smooth transitions between portrait and landscape views.

In some embodiments of the invention, the desktop panel manager 206 may control illumination, such as LEDs, on the mobile computing device 100. For example, in the case of a multicolor LED, the desktop panel manager 206 may change the color of the LED depending upon the currently active desktop panel. The desktop panel manager 206 may also change the illumination color when the content of the active desktop panel 204 is updated.

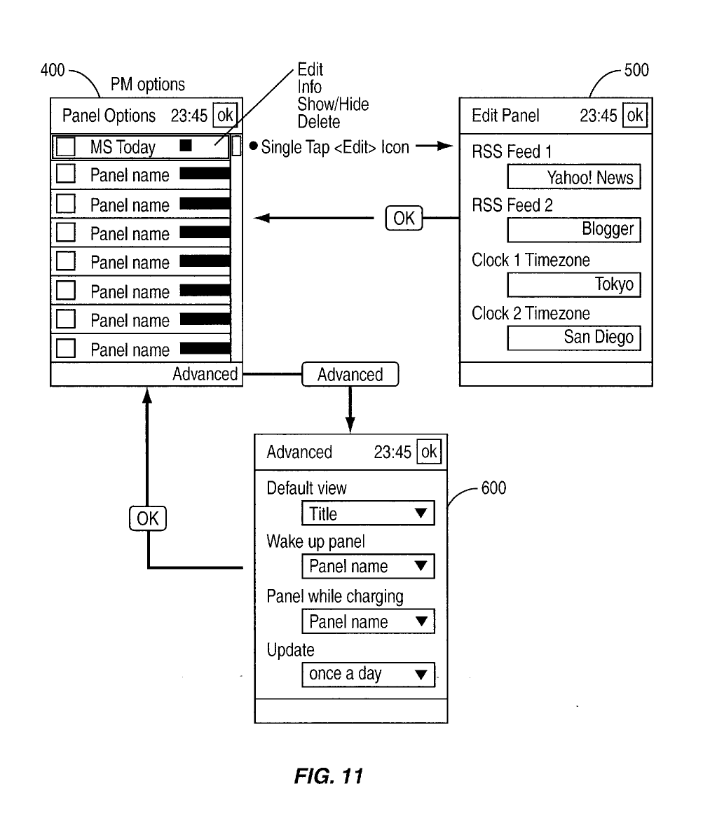

The desktop environment and the behavior of the desktop panels 204 may be configurable by the user. FIG. 11 illustrates exemplary control panels to allow the user to control the behavior of the desktop panels 204. To avoid confusion, it should be noted that the term “control panel” as used herein simply denotes an input screen or dialogue box that is used to set user preferences that control the behavior of the desktop panels 204. A control panel is not a desktop panel 204. In the exemplary embodiment, three different control panels are shown: an option panel 400, an edit panel 500, and an advanced option panel 600. The options panel 400 may be invoked, for example, by selecting the “Options” command on the selection panels 300a, 300b shown in FIG. 5. The options panel 400 displays a list of desktop panels 204 that are installed on the mobile computing device 100. As previously indicated, the user may have any number of panels. However, only nine panels can be enabled at any given time. The user can select which desktop panels 204 to enable through the options panel 400.

Each desktop panel 204 may provide a set of user-configurable settings. The user may select a desktop panel 204 from the options panel 400 for editing by highlighting the corresponding entry in the panel list and selecting the “Edit” command on the options panel 400. Alternatively, the user can select a desktop panel 204 for editing by tapping or “clicking on” a corresponding entry in the panel list. FIG. 11 illustrates an exemplary edit panel 500 that allows the user to set the RSS feeds provided by an exemplary desktop panel 204 and setting the time zone for clocks in an exemplary user desktop.

The advanced options panel shown in FIG. 11 can be entered by selecting the “Advanced” command on the options panel 400. The advanced options panel 500 allows the user to set the default preview mode (e.g., tile or arc) and to control how often the desktop panels 204 are updated. Additionally, the advanced options panel 500 allows the user to select which desktop panels 204 are made active responsive to predetermined events. In this example, the user can select a wake-up panel and a charging panel. The wake-up panel is a desktop panel 204 that is activated responsive to a wake-up alarm. The charging panel is a desktop panel 204 that is activated when the mobile computing device 100 is charging. Those skilled in the art will appreciate that the illustrated events are illustrative only and that other events could be defined. There is no limit to the number of events that can be defined.

The desktop environment provided by the present invention provides a more dynamic user experience than a conventional static desktop. Each desktop panel 204 provides a unique user experience. The user can change desktop panels 204 depending on the particular experience that the user desires. The desktop environment provides an easy and quick approach to switch from one “experience” to another. It desktop panel 204 can be accessed by the user in the same manner at the same software level. The user does not have to navigate through multiple software levels to reach a desired experience.

Another advantage of the desktop panel architecture is that network operators, website operators and third party providers can create custom desktop panels. The desktop panel architecture may include a web panel component to enable website operators to create desktop panels for their customers. For example, websites such as CNN, YouTube, Google, Facebook, etc., can create custom desktop panels 204 that expose their service as a desktop panel. By providing a custom desktop panel 204 to users, the website operators allow the user easy access to their services. The users can download custom desktop panels 204 for commonly visited websites. By including a web desktop panel 204 in the set of available desktop panels 204, the user can easily access the website simply activating the corresponding desktop panel 204.

The present invention may, of course, be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

1. A method for providing to a user of a mobile computing device, multiple user desktops on a display of said mobile computing device, said method comprising:
storing a plurality of plug-in desktop panels corresponding to respective user desktops in memory of said computing device, each panel containing application code associated with a respective user desktop and configured to plug in to a desktop module having a plug-in interface;
switching between user desktops by unloading a currently active desktop panel corresponding to a first user desktop from said desktop module and loading a second desktop panel corresponding to a second user desktop in to said desktop module.

2. The method of claim 1 further comprising detecting an event and switching between user desktops responsive to said detected event.

3. The method of claim 2 wherein said predetermined event comprises one of a time-based event or location based event.

4. The method of claim 2 wherein detecting an event comprises detecting that said mobile computing device is docked.

5. The method of claim 2 wherein detecting an event comprises detecting that said mobile computing device is charging.

6. The method of claim 2 further comprising associating selected panels with corresponding events, and loading a corresponding desktop panel responsive to the detection of one of said corresponding events.

7. The method of claim 6 wherein associating selected panels with corresponding events comprises receiving user input associating one or more panels with corresponding events.

8. A user interface for a mobile computing device having a display, said user interface comprising:
a desktop module with a plug-in interface;
a plurality of plug-in desktop panels corresponding to respective desktops, each panel containing application code associated with a respective user desktop and configured to plug in to a desktop module;
a panel manager to switch between user desktops by unloading a currently active desktop panel corresponding to a first user desktop from said desktop module and loading a second desktop panel corresponding to a second user desktop in to said desktop module.

9. The user interface of claim 8 wherein said panel manager is configured to detect a predetermined event and switch between user desktops responsive to said predetermined event.

10. The user interface of claim 9 wherein said predetermined event comprises one of a time-based event or location based event.

11. The user interface of claim 9 wherein said panel manager is configured to detect that said mobile computing device is docked.

12. The user interface of claim 9 wherein said panel manager is configured to detect that said mobile computing device is charging.

13. The user interface of claim 9 wherein said panel manager is configured to associate selected panels with corresponding predetermined events, and to load a corresponding desktop panel responsive to the detection of one of said predetermined events.

14. The user interface of claim 15 wherein said panel manager is configured to receive user input associating selected panels with corresponding predetermined events.
